(19) United States
(12) Patent Application Publication
(10) Pub. No.: US 2005/0070683 A1
(43) Pub. Date: Mar. 31, 2005

(54) Solidification-stable blocked polyisocyanates

(76) Inventors: Christoph Thiebes, Koln (DE); Frank Richter, Leverkusen (DE); Reinhard Halpaap, Odenthal (DE); Beate Baumbach, Burscheid (DE); Dieter Mager, Leverkusen (DE); Christian Fussel, Tonisvorst (DE)

Correspondence Address: BAYER MATERIAL SCIENCE LLC, 100 BAYER ROAD, PITTSBURGH, PA, 15205, US

(21) Appl. No.: 10/847,529

(22) Filed: May 17, 2004

(30) Foreign Application Priority Data
May 21, 2003 (DE) 10322911.6

(51) Int. Cl. C08G 18/00

(52) U.S. Cl. 528/44

(57) ABSTRACT

Storage-stable Polyisocyanates based on aliphatic and/or cycloaliphatic diisocyanates including from 1 to 20% by weight of alkylamino groups of the formula R¹R²N as a constituent of biuret groups, wherein R¹ and R² independently of one another are aliphatic or cycloaliphatic C₁-C₁₂ alkyl radicals, and where at least 95 mol % of the isocyanate groups are blocked with at least one blocking agent, and the polyisocyanates contain from 4.0 to 21.0% by weight of blocked and free NCO groups (calculated as NCO, molecular weight=42). The polyisocyanates are used to produce coating compositions, coatings, and coated substrates.

### CROSS REFERENCE TO RELATED PATENT APPLICATION

The present patent application claims the right of priority under 35 U.S.C. §199 (a)-(d) of German Patent Application No.103 22 911.6, filed May 3, 2003.

### FIELD OF THE INVENTION

The present invention relates to new storage-stable blocked polyisocyanates, to a process for preparing them and to their use for producing coatings.

### BACKGROUND OF THE INVENTION

The blocking of polyisocyanates has long been general practice for the preparation, among other things, of crosslinker components for 1K (1-component) polyurethane coating systems for utilities including, for example, automotive OEM finishing, the coating of plastics, and coil coating. The use, for example, of 1,2,4-triazole, diisopropylamine or diethyl malonates for polyisocyanate blocking leads to coating systems having a particularly low crosslinking temperature. This is of importance not only from an economic standpoint but also for the coating of thermally sensitive substrates such as plastics (“Polyurethane für Lacke und Beschichtungen”, Vincentz Verlag, Hannover, 1999).

Organic solutions particularly of polyisocyanates blocked with 1,2,4-triazole, diisopropylamine or diethyl malonates, however, are not storable for months, since they have a very high tendency to solidify as a result, for example, of crystallization of the blocked polyisocyanate they contain. This tendency is particularly pronounced for polyisocyanates with an isocyanurate structure based on linear aliphatic diisocyanates. Consequently they are unsuitable for use in solventborne 1K PU coating systems.

In special cases it is possible to obtain blocked polyisocyanates whose solutions in organic solvents do not tend towards solidification as a result, for example, of crystallization, by dint of using two or more different blocking agents (so-called mixed blocking) (cf. e.g. EP-A 0 600 314, EP-A 0 654 490). As compared with the use of a single blocking agent, however, mixed blocking always represents an increased cost and inconvenience in the preparation of the blocked polyisocyanates. Furthermore, the coating properties may be affected in a particularly adverse way by the blocking agent mixture released, and so polyisocyanates with mixed blocking are not suitable for general use.

In accordance with the teaching of DE-A 197 38 497 blocked polyisocyanates whose organic solutions are stable to solidification as a result, for example, of crystallization can be obtained by reacting mixtures of cycloaliphatic and aliphatic diisocyanates with secondary amines and then partially reacting some of the NCO groups with hydroxy-functional hydrazide compounds. Coating films produced from these polyisocyanates, however, have a markedly different profile of properties from those based purely on aliphatic or cycloaliphatic diisocyanates, and so are not suitable for general use.

DE-A 100 60 327 dislcoses solidification-stable polyisocyanates in which a fraction of the isocyanate groups has been reacted with 3-aminopropyltrialkoxysilanes. A disadvantage here, however, is that the isocyanate groups modified in this way are not available for a crosslinking reaction with the formation of urethane groups, which adversely affects coating properties, such as solvent and chemical resistances, for example. Moreover, with these silane-modified polyisocyanates, instances of incompatibility arise with certain film-forming binders.

The object of the present invention was to provide new blocked polyisocyanates whose organic solutions possess long-term stability and do not tend towards solidification as a result, for example, of crystallization, even after months.

### SUMMARY OF THE INVENTION

The present invention is directed to polyisocyanates based on aliphatic and/or cycloaliphatic diisocyanates containing from 1 to 20% by weight of alkylamino groups of the formula R¹R²N as a constituent of biuret groups, where R¹ and R² independently of one another are aliphatic or cycloaliphatic C₁-C₁₂ alkyl radicals. At least 95 mol % of the isocyanate groups are blocked with at least one blocking agent. The polyisocyanates contain from 4.0 to 21.0% by weight of blocked and free NCO groups (calculated as NCO, molecular weight=42).

The present invention is also directed to a process for preparing the above-described polyisocyanates including
A) reacting
   a) at least one polyisocyanate having an NCO content (calculated as NCO; molecular weight=42) of from 8.0 to 28.0% by weight and an average NCO functionality≧2 with
   b) at least one alkylamine of the formula R¹R²NH, in which R¹ and R² independently of one another are aliphatic, araliphatic or cycloaliphatic C₁-C₁₂ alkyl radicals such that from 2 to 96 mol % of the NCO groups from a) are converted into urea groups, and
B) reacting some or all of these urea groups with further NCO groups from a),
   c) optionally in the presence of a catalyst, to give biuret groups, and
C) blocking any remaining free NCO groups with
   d) a blocking agent to an extent of at least 95 mol %.

The present invention is additionally directed to a method of producing coatings or mouldings. The method includes adding one or more components selected from the group consisting of crosslinker components, antioxidants, UV absorbers, light stabilizers, solvents, plasticizers, leveling assistants, pigments, fillers, catalysts, and mixtures thereof to the above-described polyisocyanates.

The present invention is further directed to one-component coating compositions that include:
I) one or more blocked polyisocyanates as described above,
II) one or more NCO-reactive compounds with an average functionality relative to these groups of>1.5,
III) optionally solvents, and
IV) optionally auxiliaries and/or additives selected from the group consisting of plasticizers, levelling assistants, pigments, fillers, catalysts, and mixtures thereof.

The invention extends to coatings obtainable from the one-component coating compositions and substrates coated by such coatings.

### DETAILED DESCRIPTION OF THE INVENTION

Other than in the operating examples, or where otherwise indicated, all numbers or expressions referring to quantities of ingredients, reaction conditions, etc. used in the specification and claims are to be understood as modified in all instances by the term “about.”

It has now been found that polyisocyanates which have been modified by targeted incorporation of alkylamino-containing biuret structures are stable on storage, after blocking of the free NCO functions, in the form of their organic solutions and no longer tend towards solidification as a result, for example, of crystallization.

The invention provides polyisocyanates based on aliphatic and/or cycloaliphatic diisocyanates
at least 95 mol % of whose isocyanate groups are blocked with at least one blocking agent and which
contain from 4.0 to 21.0% by weight of blocked and free NCO groups (calculated as NCO, molecular weight=42%).
   characterized in that these polyisocyanates contain from 1 to 20% by weight of alkylamino groups of the formula R¹R²N, in which R¹ l and R² independently of one another are aliphatic or cycloaliphatic C₁-C₁₂ alkyl radicals, as a constituent of biuret groups.

The invention further provides a process for preparing the polyisocyanates of the invention, in which
A) in a first step
   a) at least one polyisocyanate having an NCO content (calculated as NCO: molecular weight=42) of from 8.0 to 28.0% by weight and an average NCO functionality≧2 is reacted with
   b) at least one alkylamino of the formula R¹R²NH, in which R¹ and R² independently of one another are aliphatic, araliphatic or cycloaliphatic C₁-C₁₂ alkyl radicals, such that from 2 to 96 mol % of the NCO groups from a) are converted into urea groups, and
B) some or all of these urea groups are subsequently further reacted with further NCO groups from a),
   c) optionally in the presence of a catalyst, to give biuret groups, and
C) finally any remaining free NCO groups are blocked with
   d) a blocking agent to an extent of at least 95 mol %.

As polyisocyanates of component a) it is possible to use any polyisocyanates based on aliphatic, cycloaliphatic and/or araliphatic diisocyanates and containing uretdione, isocyanurate, allophanate, biuret, iminooxadiazinedione and/or oxadiazinetrione groups, individually or in any desired mixtures with one another, these polyisocyanates preferably having a residual monomeric diisocyanate content of less than 0.5% by weight. It is unimportant whether the parent monomeric diisocyanates or triisocyanates have been prepared by phosgene processes or phosgene-free processes.

Examples of suitable diisocyanates include the following: 1,4-diisocyanatobutane, 1,6-diisocyanatohexane (HDI), 2-methyl-1,5-diisocyanatopentane, 1,5-diisocyanato-2,2-dimethylpentane, 2,2,4- and/or 2,4,4-trimethyl-1,6-diisocyanatohexane, 1,10-diisocyanatodecane, 1,3- and 1,4-diisocyanatocyclohexane, 2,6- and 2,4-diisocyanato-1-methylcyclohexane, 1,3- and 1,4-bis-(isocyanatomethyl)cyclohexane, 1-isocyanato-3,3,5-trimethyl-5-isocyanatomethylcyclohexane (isophorone diisocyanate, IPDI), 2,4- and 4,4′-diisocyanatodicyclohexylmethane, 1-isocyanatol-methyl-4(3)-isocyanatomethylcyclohexane (IMCI), bis(isocyanatomethyl)-norbornane, 1,3- and 1,4-bis(2-isocyanatoprop-2-yl)benzene (TMXDI).

Preference is given to polyisocyanates a) having an isocyanurate structure and/or iminooxadiazinedione structure, based on hexamethylene diisocyanate (HDI).

As alkylamine b) it is possible to use secondary amines of the formula R¹R²NH, in which R¹ and R² independently of one another are aliphatic, araliphatic or cycloaliphatic C₁-C₁₂ alkyl radicals or aralkyl radicals.

Particular preference is given to diisopropylamine, N,N-tert butylbenzylamine, dicyclohexylamino or mixtures of these compounds, especial preference to diisopropylamine.

As blocking agents d) it is possible to use all of the substances used under b), and also 1,2,4-triazole, alkyl acetoacetates and dialkyl malonates, or any desired mixtures of these compounds. Particular preference is given to using diisopropylamine, 1,2,4-triazole, alkyl acetoacetates and dialkyl malonates or mixtures of these compounds. Especial preference is given to using diisopropylamine.

One preferred embodiment is the use of the same alkylamine as biuretizing agent in component b) and blocking agent in component d), particularly the use of diisopropylamine for both purposes. In accordance with this preferred embodiment it is possible first of all to add a larger amount of component b) to the polyisocyanate a), and to react them to form the urea, than is necessary in order to achieve the dialkylamino group content specified under c), and subsequently to react only some of the resultant urea groups to the biuret. Preferably, however, only up to 50 equivalent %, more preferably only up to 30 equivalent %, of the NCO groups present are converted into urea groups prior to the biuretization.

In the process of the invention the starting components a) and b) are reacted with one another at temperatures from 0 to 180° C., preferably 20 to 150° C., such that first all of the amino groups of component b) react to ureas by reaction with NCO groups and subsequently at least some of these urea groups formed primarily react further, optionally in the presence of a catalyst c), to form biuret groups.

In one preferred embodiment the reaction of the polyisocyanate a) with the biuretizing agent b) is performed such that the conversion to the urea is conducted at from 0 to 100° C., preferably from 20 to 80° C., and subsequently the urea groups formed primarily are reacted with free isocyanate groups at from 100 to 180° C. preferably from 120 to 150° C. In the process of the invention the course of the conversion can be followed by means, for example, of titrimetric determination of the NCO content.

It is possible to use a catalyst c) for accelerating the biuretization reaction. Suitable examples include acids, preferably α,α,α-substituted acetic acid derivatives, more preferably hydroxypivalic acid and pivalic acid

The amount of the catalyst c) for optional use is from 0.0001 to 5% by weight, preferably from 0.05 to 1% by weight, based on the total weight of the reactants a) and b).

When the target NCO content has been reached the reaction to form the biuret is terminated. This can be done, for example, by cooling the reaction mixture to room temperature.

The biuretization reaction is followed by the reaction with the blocking agent d) to form the blocked polyisocyanates of the invention.

The blocking reaction takes place in accordance with methods known to the person skilled in the art, by direct reaction of the remaining free NCO groups with the blocking agent d) in a molar ratio of from 0.95 to. 1.5 preferably from 0.98 to 1.05. in particular 1:1.

Where different substances are used as components b) and d) it is likewise possible to react some of the NCO groups present with the blocking agent d) even before the end of the biuretization reaction. Irrespective of the procedure adopted, at least 95 mol %, preferably at least 98 mol %, more preferably at least 99.5 mol % of the NCO groups are in blocked form in the polyisocyanates of the invention.

The process of the invention can be conducted optionally in a suitable solvent which is inert towards isocyanate groups. Examples of suitable solvents are the paint solvents customary per se, such as ethyl acetate, butyl acetate, 1-methoxyprop-2-yl acetate, 3-methoxy-n-butyl acetate, acetone, 2-butanone, 4-methyl-2-pentanone, cyclohexanone, toluene, xylene, N methylpyrrolidone, chlorobenzene, for example. Mixtures containing principally aromatics with relatively high levels of substitution, such as are in commerce, for example, under the designations Solvent Naphtha, Solvesso® (Exxon Chemicals, Houston, USA), Cypar®, Cyclo Sol®. Tolu Sol®, Shellsol® (all from Shell Chemicals, Eschborn, DE), are likewise suitable. Alternatively the solvents can be added following the preparation of the blocked polyisocyanates of the invention, for the purpose, for example, of lowering the viscosity. In this case it is also possible to use alcohols, such as isobutyl alcohol, for example, since at this point all of the NCO groups present have undergone reaction with the isocyanate-reactive groups of components b) and d).

Preferred solvents are acetone, butyl acetate, 2-butanone, 1-methoxyprop-2-yl acetate, xylene, toluene, isobutyl alcohol, mixtures containing primarily aromatics with relatively high levels of substitution, such as are in commerce, for example, under the designations Solvent Naphtha, Solvesso® (Exxon Chemicals, Houston, USA), Cypar®, Cyclo Sol®, Tulu Sol®, Shellsol® (all from Shell Chemicals, Eschborn, DE).

In one preferred embodiment the solvent is not added until after the biuretization reaction (step B) has finished.

The compositions of the invention can be used as a constituent in coating materials or for producing polyurethane materials. In particular they can be used as a crosslinker component in 1K baking varnishes, especially for the coating of plastics, automotive OEM finishing, or coil coating.

The invention further provides one-component baking systems comprising
I) one or more blocked polyisocyanates of the inventive kind,
II) one or more NCO-reactive compounds with an average functionality, based on these groups, of>1.5
III) optionally solvents
IV) optionally auxiliaries and/or additives.

For the preparation of 1K baking varnishes the blocked polyisocyanates of component I) according to the invention are mixed with the coating binders of component II) which are known in coatings technology, where appropriate with the admixing of further constituents such as solvents and/or auxiliaries and/or additives such as plasticizers, levelling assistants, pigments, fillers, or catalysts which accelerate the crosslinking reaction. Care should be taken to ensure that mixing is carried out below the temperature at which the blocked NCO groups can react with the other constituents. Mixing takes place preferably at temperatures between 15 and 100° C.

The compounds used as coating binders in the 1K baking varnishes, which are crosslinked with the compositions of the invention, contain on average at least 1.5, preferably at least 2. NCO-reactive groups per molecule, such as hydroxyl, mercapto, unsubstituted or substituted amino or carboxylic acid groups, for example.

The coating binders used are preferably dihydroxyl and polyhydroxyl compounds, such as polyhydroxy polyesters, polyhydroxy polyethers or other hydroxyl-containing polymers, examples being the polyhydroxy polyacrylates which are known per se and have a hydroxyl number of from 20 to 200 mg KOH/g, preferably from 50 to 130 mg KOH/g, based on products in 100% form, or polyhydroxy carbonates or polyhydroxy urethanes.

Examples of suitable polyester polyols are, in particular, the reaction products, known per se in polyurethane chemistry, of polyhydric alcohols, for example of alkane polyols such as neopentyl glycol, ethylene glycol, 1,2- and/or 1,3-propanediol, 1,2- and/or 1,3 and/or 1,4-butanediol, trimethylolpropane, glycerol, pentaerythritol, 1,5-pentanediol and 1,6-hexanediol, with deficit amounts of pulycarboxylic acids and/or polycarboxylic anhydrides, especially dicarboxylic acids and/or dicarboxylic anhydrides. Examples of suitable polycarboxylic acids or polycarboxylic anhydrides include suberic acid, oxalic acid, succinic acid, itaconic acid, pimelic acid, azelaic acid, adipic acid, phthalic acid, isophthalic acid, tetrahydrophthalic acid, hexahydro-phthalic acid, maleic acid, the Diels-Alder adducts thereof with cyclopentadiene, fumaric acid or dimeric and/or trimeric fatty acids, and also the anhydrides of the stated acids. For the preparation of the polyester polyols it is of course possible to use any desired mixtures of the polyhydric alcohols exemplified or any desired mixtures of the acids and/or acid anhydrides exemplified. The polyester polyols have, for example, a number-average molecular weight (Mₙ) of from 500 to 10 000 g/mol. preferably from 800 to 5000 g/mol, more preferably from 1000 to 3000 g/mol.

The polyester polyols are prepared by known methods, as described in, for example, Houben-Weyl, Methoden der organischen Chemie, volume XIV/2, G. Thieme-Verlag, 1963, pages 1 to 47. Any required hydrophilic modification of these polyhydroxyl compounds is accomplished in accordance with methods known per se, as described in, for example, EP-A 157 291 or EP-A 427 028.

Suitable polyether polyols are the ethoxylation and/or propoxylation products, known per se from polyurethane chemistry, of suitable 2- to 4-valent starter molecules such as, for example, water, ethylene glycol, propanediol, trimethylolpropane, glycerol and/or pentaerythritol.

The polyhydroxyl polyacrylates are conventional copolymers of styrene with simple esters of acrylic acid and/or methacrylic acid, the hydroxyl groups being introduced through the use of hydroxyalkyl esters, such as the 2-hydroxyethyl, 2-hydroxypropyl, 2-, 3- or 4-hydroxybutyl esters of these acids, for example.

It is also possible to prepare waterborne 1K polyurethane coating materials, by dispersing the optionally solvent-containing blocked polyisocyanates of the invention in water, together with a hydrophilically modified hydroxyl-containing polymer. Hydrophilically modified hydroxyl-containing polymers can contain anionic, cationic and non-ionic groups as hydrophilicizing groups, examples being sulphonate, carboxylate and polyether groups.

The 1K polyurethane coating materials obtained in conjunction with diols and polyols are particularly suitable for producing high-grade coatings. The equivalent ratio of NCO-reactive groups to blocked and non-blocked NCO groups is preferably from 0.5 and 3, more preferably from 0.90 to 1.50, especially preferably from 1.00 to 1.25.

In addition to the polyisocyanates of the invention it is possible if desired to use further compounds, reactive towards the compounds of the component II), as a further crosslinker component. Examples of such compounds include amino resins and/or compounds containing epoxide groups. Resins regarded as amino resins are the condensation products, known in coatings technology, of melamine and formaldehyde, or of urea and formaldehyde. Suitability is possessed by all conventional melamine-formaldehyde condensates, unetherified or etherified with saturated monoalcohols having 1 to 4 carbon atoms. Where other crosslinker components are used the amount of binder having NCO-reactive groups must be adapted accordingly.

Examples of optional auxiliaries or additives include antioxidants such as 2,6-di-tert-butyl-4-methylphenol, UV absorbers of the 2-hydroxyphenylbenzotriazole type or light stabilizers of the type of HALS compounds substituted or unsubstituted on the nitrogen atom, such as Tinuvin® 292 and Tinuvin® 770 DF (Ciba Spezialitäten GmbH, Lampertheim, DE) or other standard commercial stabilizers, as described in, for example, “Lichtschutzmittel für Lacke” (A. Valet, Vincentz Verlag, Hannover, 1996 and “Stabilization of Polymeric Materials” (H. Zweifel, Springer Verlag, Berlin, 1997, Appendix 3, pp. 181-213), or any desired mixtures of these compounds. In addition it is also possible to use stabilizers containing hydrazide groups and/or hydroxy-functional stabilizers such as the adduct of hydrazine with propylene carbonate that is described in EP-A 0 829 500.

The preferred use is that in solventborne coating materials. It will be appreciated that use in aqueous coating materials or, albeit less preferably, in powder coating materials is also possible.

These coating materials can be used to coat various substrates, especially to coat metals and plastics. The substrates may have already been coated with other coating films, so that a further coating film is applied by the operation of coating with the coating material comprising the composition of the invention.

The blocked polyisocyanates of the invention can be used for the preparation of baking varnishes, for industrial coating, for example, and in automotive OEM finishing. For this purpose the coating materials of the invention can be applied by knife coating, dipping, spray application such as compressed-air spraying or airless spraying, and also by electrostatic application—high-speed rotary bell application, for example.

The substrates to be coated may have already been coated with other coating films, so that a further coating film is applied by the operation of coating with the coating material comprising the composition of the invention. The dry film thickness can be, for example, from 10 to 120 μm. The dried films are cured by baking in temperature ranges from 90 to 160° C., preferably from 110 to 140° C. The blocked polyisocyanates of the invention can be used for the preparation of baking varnishes for continuous coil coating, in which case it is possible to achieve maximum baking temperatures, known to the person skilled in the art as peak metal temperatures (PMT), of between 130 and 300° C., preferably from 190 to 260° C., and dry film thicknesses of, for example, from 3 to 40 μm.

### EXAMPLES

In the examples below, unless specified otherwise, all percentages are % by weight.

Solids content and BNCO content are calculated variables, which are calculated as follows:
Solids content in %=[(total weight-total weight of the solvents) divided by total weight] multiplied by 100
BNCO content in %=[(eq of blocked NCO groups multiplied by 42) divided by total weight] multiplied by 100.

The NCO content was determined by titration in accordance with DIN 53 185.

The end of the blocking reaction was detected by means of IR spectroscopy measurements on an Arid-Zone® spectrometer from Bomen, Quebec, Canada (NCO vibration 2200 to 2250 cm⁻¹).

A reference to room temperature is understood to be 23±3° C.

### Starting Materials

Polyisocyanate 1

HDI-based polyisocyanate containing isocyanurate groups, having an NCO content (based on NCO, molecular weight=42) of 21.7% by weight, having an average isocyanate functionality of 3.4 (by GPC) and a monomeric HDI content of 0.1%. Viscosity at room temperature 3000 mPas.

Polyisocyanate 2

HDI-based polyisocyanate containing iminooxadiazinedione groups, having an NCO content (based on NCO, molecular weight=42) of 23.2% by weight, having an average isocyanate functionality of 3.3 (by GPC) and a monomeric HDI content of 0.1%, prepared according to EP-A 798299. Viscosity at room temperature 700 mPas.

### Example 1 (Inventive)

Diisopropylamine-biuret group-containing polyisocyanate, diisopropylamine-blocked

193.5 g (1.00 eq) of polyisocyanate 1 were admixed with 50.5 g (0.5 eq) of diisopropylamine with stirring under dry nitrogen, a slight exotherm being observed. The batch was heated further to 140° C. and, following the addition of 1.00 g of hydroxypivalic acid, was stirred at this temperature for 5 h. At this point an NCO content of 5.5% by weight (corresponding to 0.32 eq of NCO) was measured and the batch was cooled to room temperature, diluted with 75 g of isobutanol and 75 g of methoxypropyl acetate (MPA) and subsequently admixed with 32.3 g of diisopropylamine. After the end of the blocking reaction (disappearance of the NCO band from the IR spectrum) 426.3 g of a colourless, clear product were obtained, having the following characteristics:
Viscosity at 23° C.: 3200 mPas
Amount of alkylamino groups NCH(CH₃)₂ in biuret groups: 4.3% (0.18 eq)
Blocked NCO group content (M=42): 8.1% (0.82 eq BNCO)
Solids content: 64.8%

After storage of the product at room temperature for 3 months neither any clouding of the solution nor any kind of solids precipitation or crystallization was observed.

### Example 2 (Inventive)

Diisopropylamine-biuret group-containing polyisocyanate, diisopropylamine-blocked

181.0 g (1.00 eq) of polyisocyanate 2 were admixed with 5.05 g (0.05 eq) of diisopropylamine with stirring under dry nitrogen, a slight exotherm being observed. The batch was heated further to 140° C. and was stirred at this temperature for 2 h. At this point an NCO content of 20.3% by weight (corresponding to 0.90 eq of NCO) was measured and the batch was cooled to room temperature, diluted with 75 g of isobutanol and 75 g of methoxypropyl acetate (MPA) and subsequently admixed with 90.9 g of diisopropylamine. After the end of the blocking reaction (disappearance of the NCO band from the IR spectrum) 426.95 g of a colourless, clear product were obtained, having the following characteristics:
Viscosity at 23° C.: 2590 mPas
Amount of alkylamino groups NCH(CH₃)₂ in biuret groups: 2.4% (0.1 eq)
Blocked NCO group content (M-42): 8.6% (0.9 eq)
Solids content: 65%

After storage of the product at room temperature for 3 months neither any clouding of the solution nor any kind of solids precipitation or crystallization was observed.

Described below is the preparation of a product based on the same starting polyisocyanate and on the same blocking agent, which contains no biuret groups.

### Example 3 (Comparative)

Isocyanurate group-containing polyisocyanate, diisopropylamine-blocked

193.5 g of polyisocyanate 1 were diluted with 79.3 g of methoxypropyl acetate (MPA) and 101.0 g of diisopropylamine were added with stirring under dry nitrogen, a slight exotherm being observed. Following complete addition, the mixture was heated to −70° C. and after 30 minutes of stirring at this temperature the batch was cooled to room temperature. Free isocyanate groups were subsequently no longer detectable in the IR spectrum. Finally the product was diluted with a further 79.3 g of isobutanol to give a clear, virtually colourless product having the following characteristics.
Viscosity at 23° C.: 2070 mPas
Blocked NCO group content (molecular weight=42): 9.3%
Solids content: 65%

After 14 days of storage at room temperature solidification by crystallization began. After 18 days of storage at room temperature a solid, white, opaque mass had formed.

### Example 4 (Comparative)

Iminooxadiazinetrione group-containing polyisocyanate, diisopropylamine-blocked

181.0 g of polyisocyanate 2 were diluted with 76.0 g of methoxypropyl acetate (MPA) and 101.0 g of diisopropylamine were added with stirring under dry nitrogen, a slight exotherm being observed. Following complete addition, the mixture was heated to 70° C. After 30 minutes of stirring at this temperature the batch was cooled to room temperature. After this point in time, free isocyanate groups were no longer detectable in the IR spectrum. Subsequently the product was diluted with a further 76.0 g of isobutanol to give a clear, virtually colourless product having the following characteristics.
Viscosity at 23° C.: 1560 mPas
Blocked NCO group content (molecular weight=42): 9.7%
Solids content: 65%

After 14 days of storage at room temperature solidification by crystallization began. After 18 days of storage at room temperature a solid, white, opaque mass had formed.

### Example 5 (Inventive)

Diisopropylamine-biuret group-containing polyisocyanate, diethyl malonate-blocked

193.5 g (1.00 eq) of polyisocyanate 1 were admixed with 5.05 g (0.05 eq) of diisopropylamine with stirring under dry nitrogen, a slight exotherm being observed. The batch was heated further to 140° C. and stirred at this temperature for 2 h. At this point an NCO content of 19.0% by weight (corresponding to 0.90 eq of NCO) was measured and the batch was cooled to room temperature and diluted with 183.3 g of butyl acetate, 96 g of diethyl malonate were added and a mixture of 48 g of diethyl malonate, 0.65 g of sodium methoxide and 1.5 g of methanol was added dropwise at a rate such that, in the exothermic reaction, the temperature did not exceed 70° C. After 120 minutes of stirring at this temperature the batch was cooled. After this point in time, free isocyanate groups were no longer detectable in the IR spectrum. This gave 526.5 g of a colourless, clear product having the following characteristics:
Viscosity at 23° C.: 2200 mPas
Amount of alkylamino groups NCH(CH₃)₂ in biuret groups: 1.9% (0.1 eq)
Blocked NCO group content (M=42): 7.2% (0.9 eq)
Solids content: 65%

Described below is the preparation of a product based on the same starting polyisocyanate and on the same blocking agent, which contains no biuret groups.

### Example 6 (Comparative)

Isocyanurate group-containing polyisocyanate, diethyl malonate-blocked

A mixture of 193.5 g of polyisocyanate A1), 152.5 g of butyl acetate and 106.7 g of diethyl malonate was admixed dropwise, with stirring under dry nitrogen, with a mixture of 53.3 g of diethyl malonate, 0.72 g of sodium methoxide and 1.68 g of methanol at a rate such that, in the exothermic reaction, the temperature did not exceed 70° C. After 120 minutes of stirring at this temperature the batch was cooled. After this point in time, free isocyanate groups were no longer detectable in the IR spectrum. This gave a clear, pale yellow product having the following characteristics.
Blocked NCO group content (molecular weight=42): 8.3%
NCO functionality (GPC): 3.4
Solids content: 70%

First signs of crystallization appeared after 24 h of storage at room temperature; after 48 h of storage at room temperature, a solid, clear, pale yellow mass had formed. In the case of the product from Example 5 no sign of crystallization was yet detectable after 14 days of storage at room temperature. From this it is clearly evident that the blocked polyisocyanates of the invention are stabilized with respect to crystallization.

### Example 7

Preparation and testing of the properties of coating materials based on some of the polyisocyanates described in the examples (inventive and comparative)

Based on the blocked polyisocyanate from Example 1 and the hydroxy-functional polyester polyol Desmophen® T 1665 from Bayer AG, Leverkusen, DE (hydroxyl content, solvent-free in accordance with DIN 53 240/2 approx. 2.6%, 65% in Solventnaphtha® 100/isobutanol 31.5:3.5, equivalent weight 1000), a coil coating material was prepared. Additionally used were the white pigment Tronox® R-KB-4 from Kerr-McGee, Krefeld-Uerdingen, DE and also, as further additives, cellulose acetobutyrate CAB 531-1 from Krahn Chemie GmbH, Hamburg, DE, dibutyltin dilaurate from Brenntag, Mühlheim/Ruhr, DE, Acronal® 4 F from BASF AG, Ludwigshafen, DE, and, as solvent, Solvesso® 200 S from Deutsche Exxon, Cologne, DE.

TABLE 1
Composition of the paints

| | | | Desmophen ® | Equiv. ratio |
|---|---|---|---|---|
| Paint | Polyisocyanate | | T 1665 | NCO:OH |
| I | Example 1 | 100 g | 192.9 g | 1:1 |
| II | Example 1 | 100 g | 241.1 g | 1:1.5 |
| III | Example 3 | 100 g | 221.4 g | 1:1 |
| IV | Example 3 | 100 g | 276.8 g | 1:1.5 |

The paints were formulated so that the ratio of hydroxyl groups in the polyester to the blocked NCO groups in the polyisocyanate was 1:1 or 1.5:1. and the ratio of the non-volatile constituents of the polyisocyanate and of the polyester to the pigment was 1:1. Based on the fraction of the non-volatile constituents in the polyisocyanate and in the polyester, the paints contained 0.3% by weight of dibutyltin dilaurate, 1.2% by weight of CAB 531-1 and 0.3% of Acronal® 4 F. The application viscosity was adjusted to a level of 100's (DIN EN ISO 2431, cup with 5 mm nozzle/23° C.) by dilution with Solvesso® 200 S.

The paints were applied by knife coating to a chromated aluminium panel and baked into a coil coating test oven from Aalborg at 350° C. in each case for a time sufficient to achieve the peak metal temperatures (PMT) indicated in Table 2.

TABLE 2
Test results for the paints

| | Paints | | | |
|---|---|---|---|---|
| | | | III com- | IV com- |
| | I | II | parative | parative |
| Film thickness [μm] | 20 | 20 | 20 | 20 |
| [ECCA T1](*1) | | | | |
| Gardner gloss | 45/78 | 45/75 | 47/69 | 57/74 |
| at 20°/60° [ECCA-T2](*1) | | | | |
| Berger whiteness | 92.4 | 92.9 | 92.4 | 92.5 |
| (at PMT 254° C.)(*2) | | | | |
| MEK wipe test at PMT199° C., | 75 | 60 | 10 | 4 |
| Pressure: about 2 kg(*3) | | | | |
| MEK wipe test at PMT204° C., | >100 | >100 | <99 | >100 |
| Pressure: about 2 kg | | | | |
| MEK wipe test at PMT210° C., | >100 | >100 | >100 | >100 |
| Pressure: about 2 kg | | | | |
| MEK wipe test at PMT216° C., | >100 | >100 | >100 | >100 |
| Pressure: about 2 kg | | | | |
| Microhardness penetration depth | 155.7 | 155.5 | 158.2 | 157.0 |
| [μm]HU corr. N/mm²(*4) | | | | |
| Erichsen cupping | GT 0 | GT 0 | GT 0 | GT 0 |
| Crosshatch [6 mm] | | | | |
| [ECCA-T6](*1) | | | | |

(*1)Standards of the European Coil Coating Association
(*2)Measured with instrument of the color-guide sphere type from Byk-Gardner in accordance with the CIE-L*a*b* scale
(*3)Double rubs until the paint film softens
(*4)Measured with the Fischerscope H100 SMC from Fischer

In the case of the two paints III and IV a solid had settled after 30 days, whereas the paints I and II, comprising the blocked polyisocyanate of the invention from Example 1, showed no sign of any crystallization even after more than 3 months of storage.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

1. Polyisocyanates based on aliphatic and/or cycloaliphatic diisocyanates comprising from 1 to 20% by weight of alkylamino groups of the formula R¹R²N as a constituent of biuret groups, wherein R¹ and R² independently of one another are aliphatic or cycloaliphatic C₁-C₁₂ alkyl radicals, and wherein
at least 95 mol % of the isocyanate groups are blocked with at least one blocking agent, and
the polyisocyanates contain from 4.0 to 21.0% by weight of blocked and free NCO groups (calculated as NCO, molecular weight=42).

2. The polyisocyanates according to claim 1, wherein the alkylamino groups of the formula R¹R²N are diisopropylamino, N,N-tert-butylbenzylamino and/or dicyclohexylamino groups.

3. A process for preparing the polyisocyanates according to claim 1, comprising
A) reacting
a) at least one polyisocyanate having an NCO content (calculated as NCO; molecule weight=42) of from 8.0 to 28.0% by weight and an average NCO functionality≧2 with
b) at least of the formula R¹R¹NH, in which R¹ and R² independently of one another are aliphatic. araliphatic or cycloaliphatic C₁-C₁₂ alkyl radicals such that from 2 to 96 mol % of the NCO groups from a) are converted into urea groups, and
B) reacting some or all of these urea groups with further NCO groups from a),
c) optionally in the presence of a catalyst, to give biuret groups, and
C) blocking any remaining free NCO groups with
d) a blocking agent to an extent of at least 95 mol %.

4. The process according to claim 3, wherein diisopropylamine, N,N-tert-butylbenzylamine, dicyclohexylamine and/or mixture thereof are used as alkylamine of component b).

5. The process according to claim 3, wherein from 0.05 to 1% by weight of hydroxypivalic acid or pivalic acid is used as catalyst component c).

6. A method of producing coatings or mouldings comprising adding one or more components selected from the group consisting of crosslinker components, antioxidants, UV absorbers, light stabilizers, solvents, plasticizers, levelling assistants, pigments, fillers, catalysts, and mixtures thereof to the polyisocyanate according to claim 1.

7. One-component coating compositions comprising
I) one or more blocked polyisocyanates according to claim 1,
II) one or more NCO-reactive compounds with an average functionality relative to these groups of>1.5,
III) optionally solvents, and
IV) optionally auxiliaries and/or additives selected from the group consisting of plasticizers, levelling assistants, pigments, fillers, catalysts, and mixtures thereof.

8. Coatings obtainable from coating compositions according to claim 7.

9. Substrates coated with coatings according to claim 8.

10. The process according to claim 4, wherein from 0.05 to 1% by weight of hydroxypivalic acid or pivalic acid is used as catalyst component c).

11. A method of producing coatings or mouldings comprising adding one or more components selected from the group consisting of crosslinker components, antioxidants, UV absorbers, light stabilizers, and mixtures thereof to the polyisocyanate according to claim 2.

12. One-component coating compositions comprising
I) one or more blocked polyisocyanates according to claim 2,
II) one or more NCO-reactive compounds with an average functionality relative to these groups of>1.5,
III) optionally solvents, and
IV) optionally auxiliaries and/or additives selected from the group consisting of plasticizers, levelling assistants, pigments, fillers, catalysts, and mixtures thereof.

13. Coatings obtainable from coating compositions according to claim 12.

14. Substrates coated with coatings according to claim 13.
